(19) United States
(12) Patent Application Publication
(10) Pub. No.: US 2013/0196144 A1
(43) Pub. Date: Aug. 1, 2013

(54) Laser Engraveable Compositions for Relief Image Printing Elements

(71) Applicants: David H. Roberts, Carlsbad, CA (US); Carol J. Moralez, Vista, CA (US)

(72) Inventors: David H. Roberts, Carlsbad, CA (US); Carol J. Moralez, Vista, CA (US)

(21) Appl. No.: 13/362,285

(22) Filed: Jan. 31, 2012

(51) Int. Cl. B32B 5/16; B29C 35/08; C09D 147/00

(52) U.S. Cl. 428/327; 522/113; 264/400

(57) ABSTRACT

A laser engravable photocurable composition comprising: (a) crosslinked elastomeric polymer particles having a diameter of between about 5 and about 1000 nm; (b) about 0 to 60 parts of at least one monomer; (c) about 0.1 to 4 parts of at least one photoinitiator; and optionally, (d) a binder or oligomer. The crosslinked elastomeric polymer particles preferably comprise: (i) an aliphatic conjugated diene monomer; (ii) at least one vinyl monomer; and (iii) optionally, an acid functional monofunctional vinyl monomer. In addition a laser engravable relief printing element including the laser engravable photocarable composition and an engraving method are also described.

### FIELD OF THE INVENTION

The present invention relates generally to laser engravable compositions for relief image printing elements and methods of using the same.

### BACKGROUND OF THE INVENTION

Flexography is a method of printing that is commonly used for high-volume runs. Flexography is employed for printing on a variety of substrates such as paper, paperboard stock, corrugated board, films, foils and laminates. Newspapers and grocery bags are prominent examples. Coarse surfaces and stretch films can be economically printed only by means of flexography. Flexographic printing plates are relief copies. Such plates offer a number of advantages to the printer, based chiefly on their durability plates with image elements raised above open areas. Generally, the plate is somewhat soft, and flexible enough to wrap around a printing cylinder, and durable enough to print over a million and the ease with which they can be made.

There are a number of methods currently used to accomplish the digital imaging of relief image printing elements, including black mask laser ablation, direct write and direct laser engraving.

In a “digital” or “direct to plate” plate making process, a laser is guided by an image stored in an electronic data file, and is used to create an in situ negative in a digital (i.e., laser ablatable) masking layer, which is generally a slip film which has been modified to include a radiation opaque material. The masking layer is affixed atop an otherwise conventional photosensitive relief layer. In a first step, a computer controlled infrared laser selectively ablates the mask layer in the areas where an image on the relief layer is desired. The plate is then exposed to a substantial blanket dose of actinic radiation (i.e., UV radiation) through the mask layers to polymerize (i.e., selectively crosslink and cure) portions of the photocurable layer not covered by the mask, thereby creating a latentimage. The unexposed relief areas are then removed in a development step which may encompass the use of a suitable solvent or thermal development, as is known in the art. The plate is thereafter post-cured in a normal fashion. Examples of laser ablatable layers are disclosed, for example, in U.S. Pat. No. 5,925,500 to Yang, et al., and U.S. Pat. Nos. 5,262,275 and 6,238,837 to Fan, the subject matter of each of which is herein incorporated by reference in its entirety. The imaging results using this approach are typically very good. However, the major down sides of this approach include the added cost of the opaque mask as well as the additional ablation step needed.

In the direct write method, no opaque mask is needed on the plate surface. The plate's relief layer is formulated to be highly sensitive to photocuring and, as such, can be photopolymerized directly in the image areas by a scanning source of the actinic radiation controlled by a computer. After exposure, the unexposed relief areas are removed with a suitable solvent, and the plate is dried and post-cured in a normal fashion. This method has been demonstrated to be very rapid at lower resolutions and thinner reliefs but has difficulty forming good shoulder angles on fine dots, especially at thicker reliefs.

In laser engraving, an infrared laser, directed by a computer, scans progressively across the surface of the relief image printing plate and ablatively removes the non-image area of the relief. The concentrated energy of the infrared laser rapidly heats the relief layer to the point that it vaporizes and is thereby removed as a mostly gaseous material. No mask is required, and no washout, drying or post curing steps are needed. In some situations, a small amount of residue from the ablation remains on the plate surface that needs to be removed by a quick rinse or by wiping with a suitable solvent.

Laser engraving is the most simple of the digital relief image printing plate methods. It requires only a single step to go from a digital file on a computer to a press-ready relief plate. There are no intermediate steps during which the digital image can lose fidelity. In addition, there are no washing, drying and/or post curing steps that create solvent waste and that add to energy usage and total platemaking time.

Direct laser engraving has a number of advantages over the conventional production of flexographic printing plates. A number of time-consuming process steps, such as the production of a photographic negative, and development and drying of the printing plate, can be omitted. Furthermore, the edge shape of the individual relief elements can be designed individually in the laser engraving technique. While the edges of a relief dot in photopolymer plates diverge continuously from the surface to the relief floor, laser engraving also enables the engraving of an edge which drops off vertically or almost vertically in the upper region and only spreads out in the lower region. Thus, at most slight dot gain, or none at all, takes place, even with increasing wear of the plate during the printing process.

In spite of these seeming advantages, laser engraving is not one of the major methods used today in the digital production of relief image printing plates. Laser engraving is relatively slow, especially for thicker relief While the total start-to-finish time needed to prepare press-ready plates is competitive, the slow engraving time limits the overall productivity of the process from a plates-per-hour perspective. Having multiple laser engraving machines can overcome this deficiency, but the engraving machines themselves are relatively expensive.

Imaging resolution is another area that has held laser engraving back. Most commonly, the laser engraving method is used for print jobs consisting of only line work, or of halftone screens of less than 128 lines per inch (1 pi). Higher screens are sometimes attempted but can be problematic in that their finest highlight dots are difficult to hold and are often poorly shaped and inconsistent. Fine line work and small highlight dots have large surface areas relative to their volume and therefore experience considerable amounts of collateral heat from the immediately adjacent areas that are being ablated. This results in a tendency for the fine features to suffer thermal melting and a loss of image fidelity.

U.S. Pat. No. 6,880,461 to Hiller, the subject matter of which is herein incorporated by reference in its entirety, describes the use of 20 to 40% plasticizer in a photopolymer along with a crosslinking component and a styrene/butadiene block copolymer binder of 100,000 to 250,000 molecular weight to mitigate the thermal melting and loss of imaging resolution. However, the styrene-butadiene block copolymers are well known to be thermoplastic elastomeric materials and upon heating, they melt and flow.

U.S. Pat. No. 6,935,236 to Hiller et al., the subject matter of which is herein incorporated by reference in its entirety, describes the use of 0.2 to 5% by weight of an oxidic, silicious or zeolitic tiller in a photopolymer along with a photoinitiator, a polymerizable compound, a plasticizer and a thermoplastic elastomeric block copolymer hinder made from alkenyl aromatic compounds (e.g., styrene) and 1,3-dienes (e.g., butadiene or isoprene). However, these filler materials are not in themselves elastomeric which can change the physical properties in the resultant relief image printing plate. The block copolymer used is a thermoplastic material which by definition would want to melt and flow when subjected to heat.

Various methods have been suggested for improving engraving resolution and reducing the post-engraving residue including the use of nano-fillers, porous additives, plasticizers additives and hydrophilic/hydrophobic binder blends. However further improvements are necessary to provide a laser engravable composition that overcomes noted deficiencies of the prior art.

### SUMMARY OF THE INVENTION

It is an object of the present invention to provide a laser engravable photocurable composition for use in making laser engravable printing plates.

It is another object of the present invention to provide a laser engravable photocurable printing element.

It is still another object of the present invention to provide a laser engravable photocurable composition that is resistant to melt flow.

It is yet another object of the present invention to provide a laser engravable photocurable composition that has good fidelity and consistency upon engraving.

It is still another object of the present invention to reduce the amount of residue produced during the engraving step.

It is still another object of the present invention to provide a laser engravable photocurable printing element that requires little or no washing prior to mounting on a printing press for use.

To that end, in a preferred embodiment, the present invention relates generally to a laser engravable photocurable composition comprising:
a) crosslinked elastomeric polymer particles having a diameter of between about 5 and about 1000 nm;
b) at least one monomer;
c) at least one photoinitiator; and
d) optionally, a binder or oligomer.

The crosslinked elastomeric polymer particles preferably comprise:
a) an aliphatic conjugated diene monomer;
b) at least one vinyl monomer; and
c) optionally, an acid functional monofunctional vinyl monomer;

In another preferred embodiment, the present invention also relates generally to a laser engravable relief printing element comprising:
a) a flexible support;
b) optionally, an adhesion and/or anti-reflectance layer;
c) a laser engravable layer, said laser engravable layer comprising:
   i) crosslinked elastomeric polymer particles, having a diameter of about 5 to 1,000 nm
   ii) at least one monomer;
   iii) at least one photoinitiator; and
   iv) optionally, a binder or oligomer; and
d) optionally, a matte coating or a slip film layer applied to the top of the laser engravable composition.

In yet another preferred embodiment the present invention relates generally to a method of preparing a relief image printing plate by laser engraving, the method comprising the steps of:
a) providing a laser engravable photocurable layer on a flexible support, the laser engravable composition comprising:
   i) crosslinked elastomeric polymer particles, having a diameter of about 5 to 1,000 nm;
   ii) at least one monomer;
   iii) at least one photoinitiator; and
   iv) optionally, a binder or oligomer; and
b) crosslinking the laser engravable photocurable layer over the entire surface by exposing the laser engravable photocurable layer to actinic radiation; and
c) engraving a printing relief of a desired image in the crosslinked laser engravable layer using a laser.

### DETAILED DESCRIPTION OF THE PREFERRED EMBODIMENTS

The present invention provides a relief image printing plate composition that laser engraves with improved resolution.

The inventors of the present invention have found that relief image printing plate image layers formulated around nano-sized crosslinked elastomeric particles provide improved resolution for engraving by infrared laser devices.

It is believed that the non-thermoplastic nature of the crossslinked elastomeric particles makes them, and the relief layers constructed from them, strongly resistant to melt flow when the compositions experience the intense heat conducted from adjacent relief areas being engraved. As such, the relief image features are significantly less damaged by melting and are thereby rendered with more fidelity and consistency that those of the prior art

The inventors of the present invention have also found that printing plate relief layers formulated around nano-sized crosslinked elastomeric parties can be blended with a range of reactive monomers/oligomers, photoinitiators, inhibitors and other additives and still maintain the very good clarity needed in order for the resin to be properly photocured in the plate manufacturing process.

Printing plates with relief layers formulated around nano-sized crosslinked elastomeric particles can be formulated to a wide range of durometers and resiliences to meet the needs of different letterpress and flexographic printing operations. Photocurable (also known as photopolymerizable or photosensitive) resin compositions generally comprise an elastomeric binder (sometimes referred to as a prepolymer or an oligomer), at least one monomer, and a photoinitiator.

In addition, printing plate with relief layers formulated around nano-sized crosslinked elastomeric particles produce a reduced amount of residue during the engraving step and thereby require little or no washing prior to mounting on a printing press for use.

Advantages of the present invention include improved resolution of fine image detail, reduced engraving residue, excellent optical clarity of the photopolymer for easy UV cure, and adaptability to produce both letterpress and flexographic relief printing plates.

In one embodiment, the present invention relates generally to a laser engravable photocurable composition comprising:
a) crosslinked elastomeric polymer particles having a diameter of between about 5 and about 1000 nm;
b) at least one monomer;
c) at least one photoinitiator; and
d) optionally, a binder or oligomer.

The crosslinked elastomeric polymer particles preferably comprise:
a) an aliphatic conjugated diene monomer;
b) at least one vinyl monomer; and
c) optionally, an acid functional monofunctional vinyl monomer.

In one embodiment, the crosslinked elastomeric polymer particles comprise:
a) about 10-80% of the aliphatic conjugated diene monomer;
b) about 0-60% of the at least one vinyl monomer; and
c) about 0-8% of an acid functional monofunctional vinyl monomer.

In addition, the laser engravable photocurable composition typically comprises about 30 to about 90 parts of the crosslinked elastomeric polymer particles, more preferably about 40 to about 65 parts of the crosslinked elastomeric polymer particles.

The morphology of the crosslinked elastomeric polymer particles may typically be either core shell or random. In addition the crosslinked elastomeric polymer particles typically have a diameter of between about 5 to 1,000 nm, more preferably about 30 to 250 nm, and most preferably about 55 to about 100 nm.

The aliphatic conjugated diene monomer is preferably selected from the group consisting of butadiene, isoprene, chioroprene, dimethylbutadiene, and the like. Preferred aliphatic conjugated diene monomers include butadiene and isoprene. It is also possible that the crosslinked nano-sized elastomer particles could be made from other chemistries such as urethanes and acrylics.

The at least one vinyl monomer may comprise at least one of a monofunctional vinyl monomer and a polyfunctional vinyl monomer.

The at least one monofunctional vinyl monomer for use in compositions of the present invention includes monomers which have one crosslinkable ethylenically unsaturated moiety and include, for example, ethyl (meth)acrylate, methyl (meth)acrylate, isopropyl (meth)acrylate, ethylhexyl (meth)acrylate, lauryl (meth)acrylate, hydroxyethyl (meth)acrylate, β-carboxyethyl (meth)acrylate, dimethylaminopropyl (meth)acrylate, diethylaminopropyl (meth)acrylate, dimethylaminopropyl (meth)acrylamide, diethylaminopropyl (meth)acrylamide, α-methyl styrene, styrene, and the like, as well as mixtures of any two or more thereof. In a preferred embodiment, the at least one monofunctional vinyl monomer comprises one of methyl methacrylate and styrene.

The at least one polyfunctional vinyl monomer for use in compositions of the present invention includes monomers which have two or more crosslinkable ethylenically unsaturated moieties such as, for example, ethyleneglycol di(meth)acrylate, 1,6-hexanediol di(meth)acryl ate, 1,4-butanediol di(meth)acrylate, trimethylol propane tri(meth)acrylate, divinyl benzene, and the like. In a preferred embodiment, the at least one polyfunctional vinyl monomer comprises one of ethyleneglycol di(meth)acrylate and divinyl benzene.

If used, the acid functional monofunctional vinyl monomer is preferably selected from the group consisting of acrylic acid, methacrylic acid, caprolactone acid, diacrylic acid and the like as well as combinations of one or more of the foregoing. In a preferred embodiment, the acid functional monofunctional vinyl monomer comprises methacrylic acid.

The laser engravable photocurable composition also comprises at least one monomer and any polymerizable monofunctional monomers and any polymerizable polyfunctional monomers known in the art may be used in the compositions described herein. As used herein, the term “monofunctional vinyl monomer” refers to compounds having only one α,β-ethylenic site of unsaturation and the term “polyfunctional vinyl monomer” refers to compounds having more than one α,β-ethylenic site of unsaturation.

Suitable monofunctional monomers include styrene, methylstyrene, chlorostyrene, bromostyrene, methoxystyrene, dimethylaminostyrene, cyanostyrene, nitrostyrene, hydroxystyrene, aminostyrene, carboxystyrene, acrylic acid, methyl acrylate, ethyl acrylate, cyclohexyl acrylate, acrylamide, methacrylic acid, methyl methacrylate, ethyl methacrylate, propyl methacrylate, butyl methacrylate, phenyl methacrylate, cyclohexyl methacrylate, isoamyl acrylate, stearyl acrylate, lauryl acrylate, octyl acrylate, decyl acrylate, isoamylstyl acrylate, isostearyl acrylate, 2-ethylhexyl-diglycol acrylate, 2-hydroxybutyl acrylate, 2-acryloyloxyethylhexahydrophthalic acid, butoxyethyl acrylate, ethoxydiethylene glycol acrylate, methoxydiethylene glycol acrylate, methoxypolyethylene glycol acrylate, methoxypropylene glycol acrylate, phenoxyethyl acrylate, tetrahydrofurfuryl acrylate, isobomyl acrylate, 2-hydroxyethyl acrylate, 2-hydroxypropyl acrylate, 2-hydroxy-3-phenoxypropyl acrylate, vinyl ether acrylate, 2-acryloyloxyethylsuccinic acid, 2-acryloyxyethylphthalic acid, 2-acryloxyethyl-2-hydroxyethyl-phthalic acid, lactone modified flexible acrylate, t-butylcyclohexyl acrylate, vinyl pyridine, N-vinylpyrrolidone, N-vinylimidazole, 2-vinylimidazole, N-methyl-2-vinylimidazole, propyl vinyl ether, butyl vinyl ether, isobutyl vinyl ether, beta-chloroethyl vinyl ether, phenyl vinyl ether, p-methylphenyl vinyl ether, and p-chlorophenyl vinyl ether and combinations of one or more of the foregoing. In one preferred embodiment, the monofunctional monomer is an acrylate monomer.

Suitable polyfunctional monomers include monomers such as divinylbenzene, triethylene glycol diacrylate, tetraethylene glycol diacrylate, polyethylene glycol diacrylate, dipropylene glycol diacrylate, tripropylene glycol diacrylate, polypropylene glycol diacrylate, 1,4-butanediol diacrylate, 1,6-hexanediol diacrylate, 1,9-nonanediol diacrylate, neopentyl glycol diacrylate, dimethylol-tricyclodecane diacrylate, bisphenol A EO (ethylene oxide) adduct diacrylate, bisphenol A PO (propylene oxide) adduct diacrylate, hydroxypivalate neopentyl glycol diacrylate, alkoxylated dimethyloltricyclodecane diacrylate, polytetramethylene glycol diacrylate, distyryl oxalate, distyryl malonate, distyryl succinate, distyryl glutarate, distyryl adipate, distyryl maleate, distyryl fumarate, distyryl β,β′-dimethylglutarate, distyryl 2-bromoglutarate, distyryl α,α′-dichloroglutarate, distyryl terephthalate, oxalic acid di(ethyl acrylate), oxalic acid di(methyl ethyl acrylate), malonic acid di(ethyl acrylate), malonic acid di(methyl ethyl acrylate), succinic acid di(ethyl acrylate), glutaric acid di(ethyl acrylate), adipic acid di(ethyl acrylate), maleic acid di(diethyl acrylate), fumaric acid di(ethyl acrylate), β,β′-dimethylglutaric acid di(ethyl acrylate), ethylenediacrylamide, propylenediacrylamide, 1,4-phenylenediacrylamide, 1,4-phertylenebis(oxyethyl acrylate), 1,4-phenylenebis(oxymethyl ethyl acryl ate), 1,4-bis(acryloyloxyethoxy)cyclohexane, 1,4-bis(acryloyloxyrnethylethoxy) cyclohexane, 1,4-bis(acryloyloxyethoxycarbamoyl)benzene, 1,4-bis(acryloyloxymethyl-ethoxycarbamoyl)benzene, 1,4-bis(acryloyloxyethoxycarbamoyl) cyclohexane, bis(acryloyloxy-ethoxycarbamoylcyclo hexyl) methane, oxalic acid di(ethyl methacrylate), oxalic acid di(methyl ethyl methacrylate), malonic acid di(ethyl methacrylate), malonic acid dimethyl ethyl methacrylate), succinic acid di(ethyl methacrylate), succinic acid di(methyl ethyl methacrylate), glutaric acid di(ethyl methacrylate), adipic acid di(ethyl methacrylate), maleic acid di(ethyl methacrylate), fumaric acid di(ethyl methacrylate), fumaric acid di(methyl ethyl methacrylate), β,β′-dimethylglutaric acid di(ethyl methacrylate), 1,4-phenylenebis(oxyethyl methacrylate), 1,4-bis(methacryloyloxyethoxy)cyclohexane, acryloyloxyethoxyethyl vinyl ether, pentaerythritol triacrylate, pentaerythritol trimethacrylate, pentaerythritol tri(hydroxystyrene), cyanuric acid triacrylate, cyarnuric acid trimethacrylate, 1,1,1-trimethylolpropane triacrylate, 1,1,1-trimethylolpropane trimethacrylate, EO modified trimethylolpropane triacrylate, tri (propylene glycol) triacrylate, caprolactone modified trimethylolpropane triacrylate, pentaerithritol tetraacrylate, pentaerythritolethoxy tetraacrylate, dipentaerythritol hexaacrylate, ditrimethylolpropane tetraacrylate, glycerinpropoxy triacrylate, cyanuric acid tri(ethyl acrylate), 1,1,1-trimethylolpropane tri(ethylacrylate), dipentaerythritol hexaacrylate, cyanuric acid tri(ethyl vinyl ether) and combinations of one or more of the foregoing. In one preferred embodiment, the polyfunctional monomer is an acrylate monomer.

The photo-initiator absorbs light and is responsible for the production of free radicals or cations. Free radicals or cations are high-energy species that induce polymerization of monomers, oligomers and polymers and with polyfunctional monomers and oligomers thereby also inducing cross-linking. Suitable photoinitiators for use in compositions of the present invention include quinones, benzophenone and substituted benzophenones, hydroxyl alkyl phenyl acetophenones, dialkoxy acetophenones, α-halogeno-acetophenones, aryl ketones (such as 1-hydroxycyclohexyl phenyl ketone), 2-hydroxy-2-methyl-1-phenylpropan-1-one, 2-benzyl-2-dimethylamino-(4-motpholinophenyl) butan-1-one, thioxanthones (such as isopropyithioxanthone), benzil dimethylketal, bis (2,6-dimethylbenzoyl)-2,4,4-trimethylpentylphosphine oxide, trimethylbenzoyl phosphine oxide derivatives such as 2,4,6trimethylbenzoyldiphenylphosphine oxide, methyl thio phenyl morpholino ketones such as 2-methyl-1-[-4-(methylthio) phenyl]-2-morpholinopropan-1-one, morpholino phenyl amino ketones, 2,2-dimethoxy-1,2-diphenylethan-1-one or benzoin ethers, peroxides, biimidazoles, benzyl dimethyl ketal, aminoketones, benzoyl cyclohexanol, oxysul fonyl ketones, sulfonyl ketones, benzoyl oxime esters, camphorquinones, ketocournarins, Michler's ketone, and combinations of one or more of the foregoing.

These photo-initiators are readily commercially available (sometimes in mixtures of one or more photoinitiators) under the tradenames Irgacure® 184, Irgacure® 500, Irgacure® 907, Irgacure® 369, Irgacure® 651, Irgacure® 819, Irgacure® 1700, Irgacure® 1870, Darocur® 1173, Darocur® 4265, and Lucerin TPO (available from BASF Corporation), Esacure® KT046, Esacure® KT055, and Esacure® KIP150 (available from Lamberti S.p.A.), H-Nu® 470 and H-Nu® 470X (available from Spectra Group, Ltd.), and Genocure® EHA and Genocure® EPD (available from Rahn USA Corp.). The laser-engravable photocurable composition is photochemically crosslinked. For the photochemical crosslinking, as discussed above, monomeric and/or oligomeric compounds containing polymerizable groups are generally added to the laser-engravable recording layer.

The optional binder preferably comprises an A-B-A type block copolymer where A represents a non-elastomeric block, preferably a vinyl polymer or most preferably polystyrene, and B represents an elastomeric block, preferably polybutadiene or polyisoprene. Suitable polymerizable oligomers may also be used in the compositions of the invention and preferred oligomers include those that are polymerized from the monofunctional and/or polyfunctional monomers disclosed above. Particularly preferred oligomers include epoxy acrylates, aliphatic urethane acrylates, aromatic urethane acrylates, polyester acrylates, polyether acrylates, amine modified polyether acrylates and straight-chained acrylic oligomers.

The crosslinking is carried out in a manner known per se by irradiation with actinic, i.e. chemically effective, radiation. Particularly suitable radiation is UV-A radiation having a wavelength of from 320 to 400 nm, or UV-A/VIS radiation having a wavelength of from 320 to about 700 nm. The type and amount of photoinitiator is determined by the person skilled in the art depending on the desired properties of the layer.

Other optional ingredients for use in the laser engravable photocurable composition of the invention include inhibitors, plasticizers, dyes, polymers, oligomers, pigments, sensitizers, synergists, tertiary organic amines, UV absorbers, thixotropes and combinations of one or more of the foregoing.

Examples of suitable plasticizers include modified and unmodified natural oils and resins, alkyl, alkenyl, arylalkyl or arylalkenyl esters of acids, such as alkanoic acids, arylcarboxylic acids or phosphoric acid; synthetic oligomers or resins, such as oligostyrene, oligomeric styrene-butadiene copolymers, oligomeric α-methylstyrene-p-methylstyrene copolymers, liquid oligobutadienes, or liquid oligomeric acrylonitrile-butadiene copolymers; and polyterpenes, polyacrylates, polyesters or polyurethanes, polyethylene, ethylene-propylene-diene rubbers or α-methyloligo(ethylene oxide). It is also possible to employ mixtures of different plasticizers. The amount of any plasticizer present may readily be determined by one skilled in the art depending on the desired hardness of the printing plate, among other factors.

In some instances it may also be advantageous to employ reaction accelerators in the photopolymerizable systems in addition to the photoinitiators. Examples of such compounds which can be added are organic amines, phosphines, alcohols and/or thiols all of which have at least one CH group in the α position to the heteroatom. For example, primary, secondary and tertiary aliphatic, aromatic, aliphatic or heterocyclic amines may be used. Examples of such amines include butylamine, dibutylamine, tributylamine, cyclohexyl amine, benzyldiniethylamine, dicyclohexylamine, triethanolamine, N-methyldiethano lamine, phenyldiethanolamine, piperidine, piperazine, morpholine, pyridine, quinoline, ethyl p-dimethylaminobenzoate, butyl p-dimethylamino benzoate, 4,4′-bis(dimethylamino)-benzophenone (Michler's ketone) or 4,4′-bis(diethylamino)-benzophenone. Particular preference is given to tertiary organic amines such as, for example, trimethylamine, tiisopropylamine, tributylamine, octyldimethylamine, dodecyl di in ethyl amine, triethanolamine, N-methyldiethanolamine, N-butyl-diethanolamine, tris(hydroxypropyl)amine, and alkyl dimethylamino benzoate. Further examples of suitable reaction accelerators include trialkyl phosphines, secondary alcohols and thiols.

In other instances, it may be advantageous to utilize a synergist with the free radical-generating photoinitiators such as benzophenone, benzils, and the like. A synergist is a compound that contains a carbon atom with at least one hydrogen atom in the alpha position to a nitrogen atom, such as the three carbon atoms in triethylamine, which are attached to the nitrogen atom and are alpha carbon atoms. Illustrative of synergists are the tertiary amines, amines, and ureas which may be in simple organic chemical, oligomeric, or polymeric form, such as dimethylethanolamine, triethylamine, triethanolamine, methyldiethanolamine, N-methyldiethanolamine, 2-ethyl-p-(N,N-dimethylamino)benzoate, 2-ethylhexyl-p-(N,N-dimethylamino)benzoate, N,N-dimethyl-p-toluidine, (dimethylamino)ethylbenzoate, 2-n-butoxyethyl-4-dimethylamino)benzoate, 4,4′bis(N,N′-dimethylamino)benzophenone, and the like. Synergists can interact with certain photoinitiators, such as benzophenone, to form other initiating free radicals, and said other initiating free radicals can decrease the oxygen inhibition difficulty that exists with certain photoinitiators. Examples of other suitable synergists include those compounds described in U.S. Pat. No. 7,425,583 to Kura et al., the subject matter of which is herein incorporated by reference in its entirety.

In addition, rheology modifiers, such as thickeners and thixotropes, such as fumed silica, may be included in the photocurable compositions described herein.

Furthermore, to inhibit premature crosslinking during the production of laser engravable photocurable composition, thermal polymerization inhibitors and stabilizers may be added. Such stabilizers are well known in the art, and include, but are not limited to, hydroquinone monobenzyl ether, methyl hydroquinone, amyl quinone, amyloxyhydroquinone, n-butylphenol, phenol, hydroquinone monopropyl ether, phenothiazine and nitrobenzene, and mixtures thereof. These stabilizers are effective in preventing crosslinking of the prepolymer composition during preparation, processing and storage.

The laser engravable photocurable compositions described herein are typically not very absorbing of IR radiation from YAG, diode and fiber lasers, which all typically emit wavelengths below 1200 nm. Thus, when the laser engravable photocurable composition of the invention is to be engraved by a YAG, diode or fiber laser, it may be necessary to include at least one IR absorbing additive, such as an IR dye which increases the sensitivity of the photocurable composition to the IR radiation of the lasers. Thus, the main function of the IR dyes is to make a normally IR transmissive compound IR absorbing to IR wavelengths below 1200 nm. As the IR laser strikes the dye, it transfers the energy from IR-photons into heat.

However, if the IR dyes were also UV absorbing, it would not be possible to through-cure the plate, and the plate would be rendered unusable. Therefore, one of the key requirements of the IR absorbing dye is that it is essentially transmissive in the UV regime between 350-400 nm, so that it will not interfere during the UV-curing step. Typically, the laser dyes are essentially monochromatic, and the choice of the plate-setter laser wavelength, either 830 nm or 1064 nm, would accordingly govern the choice of the dye. The level of dye loadings depends on the extinction coefficient of the dye at the operating wavelength, but generally ranges from about 0.01% to about 5% by weight of the photocurable composition. Examples of IR-absorbing/UV-transmissive dyes that are commercially available include ADS830A and ADS1060A. Other dyes are available from Lambda Physik, Exciton, Inc., Acros Organics USA, Clarion Corp., and Zeneca, Inc.

The invention compositions strongly absorb IR radiation from carbon diode lasers, which emit at 10.6 microns, and therefore require no IR absorbing additives.

In another preferred embodiment, the present invention also relates generally to a laser engravable relief printing element comprising:
a) a flexible support;
b) optionally, an adhesion and/or anti-reflectance layer;
c) a laser engravable layer, said laser engravable layer photocured with actinic radiation comprising:
   i) crosslinked elastomeric polymer particles, having a diameter of about 5 to 1,000 nm
   ii) at least one monomer;
   iii) at least one photoinitiator; and
   iv) optionally, a binder or oligomer; and
d) optionally, a matte coating or a slip film layer applied to the top of the laser engravable composition.

Examples of suitable dimensionally stable flexible supports include, for example, foils made of metals, such as steel, aluminum, copper or nickel, or films made of plastic, such as polyethylene terephthalate (PET), polyethylene naphthalate (PEN), polybutylene terephthalate, polyamide or polycarbonate. Particularly suitable dimensionally stable flexible supports are dimensionally stable polyester films, in particular PET or PEN films, or alternatively thin, flexible supports made of aluminum. or stainless steel. The supports employed may also be in the form of conical or cylindrical tubes, i.e., printing “sleeves.” In this instance, glass fiber fabric or composite materials made from glass fibers and suitable polymeric materials are also suitable materials for the printing sleeves.

For better adhesion of the laser-engravable layer, the dimensionally stable support may be coated with a suitable adhesive layer and/or an anti-reflectance layer.

In another preferred embodiment, the present invention relates generally to a method of preparing a relief image printing element by laser engraving, the method comprising the steps of:
a) providing a laser engravable photocurable layer on a flexible support, the laser engravable composition comprising:
   i) crosslinked elastomeric polymer particles, having a diameter of about 5 to 1,000 nm;
   ii) at least one monomer;
   iii) at least one photoinitiator; and
   iv) optionally, a binder or oligomer; and
b) crosslinking the laser engravable photocurable layer over the entire surface by exposing the laser engravable photocurable layer to actinic radiation; and
c) engraving a printing relief of a desired image in the crosslinked laser engravable layer using a laser.

The laser engravable relief image printing element may have a laser engravable layer thickness in the range of about 5 to 245 mils, more preferably about 6 to 110 mils, and most preferably about7 to 67 mils. The laser engravable layer may be engraved to a relief depth of about 5 to 160 mils, more preferably 6 to 80 mils, and most preferably 7 to 40 mils.

The laser engravable relief image printing element may be manufactured by various methods including, for example, casting, extruding, and laminating, by way of example and not limitation.

The laser engravable relief image printing element is typically cured using actinic radiation. The actinic radiation can be UV or visible, monochromatic or broadband, continuous or pulsed, single source or plurality. The only requirement is that the actinic radiation is of a wavelength to which the photocurable layer is sensitive and in a sufficient amount to complete the cure.

Infrared lasers usable for engraving include carbon dioxide, YAG, diode, fiber, combinations of those and the like. The infrared radiation can be delivered in a continuous or pulsed manner, single source or plurality.

In addition, the format of the laser engraving machine may be flatbed, drum or external drum.

In a preferred embodiment, after the laser engraving step, the flexographic relief image printing element can be employed directly. If desired, however, the flexographic relief image printing element can subsequently be cleaned. If used the cleaning step removes layer constituents which have been loosened, but have not yet been completely removed from the plate surface. In general, simple treatment with water or alcohols is entirely adequate.

What is claimed is:

1. A laser engravable photocurable composition comprising:
a) crosslinked elastomeric polymer particles having a diameter of between about 5 and about 1000 nm;
b) at least one monomer;
c) at least one photoinitiator; and
d) optionally, a binder or oligomer.

2. The laser engravable photocurable composition according to claim 1, wherein the crosslinked elastomeric polymer particles comprise:
a) an aliphatic conjugated diene monomer;
b) at least one vinyl monomer; and
c) optionally, an acid functional monofunctional vinyl monomer.

3. The laser engravable photocurable composition according to claim 2 wherein the crosslinked elastomeric polymer particles comprise:
a) about 10-80% of the aliphatic conjugated diene monomer;
b) about 0-60% of the at least one vinyl monomer; and
c) about 0-8% of an acid functional monofunctional vinyl monomer.

4. The laser engravable photocurable composition according to claim 1, comprising about 30 to about 90 parts of the crosslinked elastomeric polymer particles.

5. The laser engravable photocurable composition according to claim 2, wherein the aliphatic conjugated diene monomer is selected from the group consisting of butadiene, isoprene, chloroprene, dimethylbutadiene and combinations of one or more of the foregoing.

6. The laser engravable photocurable composition according to claim 5, wherein the aliphatic conjugated diene monomer comprises at least one of butadiene and styrene.

7. The laser engravable photocurable composition according to claim 2, wherein the at least one vinyl monomer comprises a monofunctional vinyl monomer selected from the group consisting of ethyl (meth)acrylate, methyl (meth)acrylate, isopropyl (meth)acrylate, ethylhexyl (meth)acrylate, lauryl (meth)acrylate, hydroxyethyl (meth)acrylate, β-carboxyethyl (meth)acrylate, dimethylaminopropyl (meth)acrylate, diethylaminopropyl (meth)acrylate, dimethylaminopropyl (meth)acrylamide, diethylaminopropyl (meth)acrylamide, α-methyl styrene, styrene, and combinations of one or more of the foregoing.

8. The laser engravable photocurable composition according to claim 7, wherein the at least one monofunctional vinyl monomer comprises at least one of methyl (meth)acrylate and styrene.

9. The laser engravable photocurable composition according to claim 2, wherein the at least one vinyl monomer comprises a polyfunctional vinyl monomer selected from the group consisting of ethyleneglycol di(meth)acrylate, 1,6-hexanediol di(meth)acrylate, 1,4-butanediol di(meth)acrylate, trimethylol propane tri(meth)acrylate, divinyl benzene, and combinations of one or more of the foregoing.

10. The laser engravable photocurable composition according to claim 9, wherein the at least one polyfunctional vinyl monomer comprises at least one of ethyleneglycol di(meth)acrylate and divinyl benzene.

11. The laser engravable photocurable composition according to claim 2, wherein the acid functional monofunctional vinyl monomer is present in the laser engravable photocurable composition and is selected from the group consisting of acrylic acid, methacrylic acid, caprolactone acid, diacrylic acid and combinations of one or more of the foregoing.

12. The laser engravable photocurable composition according to claim 11, wherein the acid functional monofunctional vinyl monomer comprises methacrylic acid.

13. The laser engravable photocurable composition according to claim 1, further comprising at least one ingredient selected from the group consisting of inhibitors, plasticizers, dyes, polymers, oligomers, pigments, sensitizers, synergists, tertiary organic amines, UV absorbers, thixotropes, and combinations of one or more of the foregoing.

14. A laser engravable relief printing element comprising:
a) a flexible support;
b) optionally, an adhesion and/or anti-reflectance layer;
c) a laser engravable layer, said laser engravable layer comprising:
i) crosslinked elastomeric polymer particles, having a diameter of about 5 to 1,000 nm
ii) at least one monomer;
iii) at least one photoinitiator; and
iv) optionally, a binder or oligomer; and
d) optionally, a matte coating or a slip film layer applied to the top of the laser engravable composition.

15. The laser engravable relief printing element according to claim 13, wherein the crosslinked elastomeric polymer particles comprise:
a) an aliphatic conjugated diene monomer;
b) at least one vinyl monomer; and
c) optionally, an acid functional monofunctional vinyl monomer.

16. The laser engravable photocurable composition according to claim 15, wherein the crosslinked elastomeric polymer particles comprise:
a) about 10-80% of the aliphatic conjugated diene monomer;
b) about 0-60% of the at least one vinyl monomer; and
c) about 0-8% of an acid functional monofunctional vinyl monomer.

17. The laser engravable relief printing element according to claim 15, wherein the aliphatic conjugated diene monomer is selected from the group consisting of butadiene, isoprene, chloroprene, dimethylbutadiene and combinations of one or more of the foregoing.

18. The laser engravable relief printing element according to claim 15, wherein the at least one vinyl monomer is a monofunctional vinyl monomer selected from the group consisting of ethyl (meth)acrylate, methyl (meth)acrylate, isopropyl (meth)acrylate, ethylhexyl (meth)acrylate, lauryl (meth)acrylate, hydroxyethyl (meth)acrylate, β-carboxyethyl (meth)acrylate, dimethylaminopropyl (meth)acrylate, diethylaminopropyl (meth)acrylate, dimethylaminopropyl (meth)acrylamide, diethylaminopropyl (meth)acrylamide, α-methyl styrene, styrene, and combinations of one or more of the foregoing.

19. The laser engravable relief printing element according to claim 15, wherein the at least one monomer is a polyfunctional vinyl monomer selected from the group consisting of ethyleneglycol di(meth)acrylate, 1,6-hexanediol di(meth)acrylate, 1,4-butanediol di(meth)acrylate, trimethylol propane tri(meth)acrylate, divinyl benzene, and combinations of one or more of the foregoing.

20. The laser engravable relief printing element according to claim 15, wherein the acid functional monofunctional vinyl monomer is present in the laser engravable photocurable composition and is selected from the group consisting of acrylic acid, methacrylic acid, caprolactone acid, diacrylic acid and combinations of one or more of the foregoing.

21. The laser engravable relief printing element according to claim 14, wherein the laser engravable layer further comprises at least one ingredient selected from the group consisting of inhibitors, plasticizers, dyes, polymers, oligomers, pigments, sensitizers, synergists, tertiary organic amines, UV absorbers, thixotropes, and combinations of one or more of the foregoing.

22. The laser engravable relief printing element according to claim 14, wherein the flexible support is a material selected from the group consisting of metal foils, polyesters, polyamides and polycarbonates.

23. The laser engravable relief printing element according to claim 1.4, wherein the printing element is a printing sleeve and the flexible support is a material selected from the group consisting of metal foils, polyesters, polyamides, polycarbonates, glass fiber fabrics and composite materials made from glass fibers and polymeric materials.

24. The laser engravable relief image printing element according to claim 14, wherein the laser engravable layer comprises about 30 to about 90 parts of the crosslinked elastomeric polymer particles.

25. A method of preparing a relief image printing element by laser engraving, the method comprising the steps of
a) providing a laser engravable photocurable layer on a flexible support, the laser engravable composition comprising:
i) crosslinked elastomeric polymer particles, having a diameter of about 5 to 1,000 nm;
ii) at least one monomer;
iii) at least one photoinitiator; and
iv) optionally, a binder or oligomer; and
b) crosslinking the laser engravable photocurable layer over the entire surface by exposing the laser engravable photocurable layer to actinic radiation; and
c) engraving a printing relief of a desired image in the crosslinked laser engravable layer using a laser.

26. The method according to claim 25, wherein the crosslinked elastomeric polymer particles comprise:
a) an aliphatic conjugated diene monomer;
b) at least one vinyl monomer; and
c) optionally, an acid functional monofunctional vinyl monomer.

27. The method according to claim 26, wherein the crosslinked elastomeric polymer particles comprise:
a) about 10-80% of the aliphatic conjugated diene monomer;
b) about 0-60% of the at least one vinyl monomer; and
c) about 0-8% of an acid functional monofunctional vinyl monomer.

28. The method according to claim 25, wherein the laser engravable photocurable layer has a thickness of about 5 to 245 mils.

29. The method according to claim 25, wherein the depth of the printing relief in the crosslinked laser engravable layer is between about 5 to 160 mils.

30. The method according to claim 25, wherein the laser is selected from the group consisting of carbon dioxide, YAG, diode and fiber lasers.

31. The method according to claim 25, wherein the laser engravable layer further comprises at least one ingredient selected from the group consisting of inhibitors, plasticizers, dyes, polymers, oligomers, pigments, sensitizers, synergists, tertiary organic amines, UV absorbers, thixotropes, and combinations of one or more of the foregoing.

32. The method according to claim 25, wherein the flexible support is a material selected from the group consisting of metal foils, polyesters, polyamides and polycarbonates.

33. The method according to claim 25, wherein the printing element is a printing sleeve and the flexible support is a material selected from the group consisting of metal foils, polyesters, polyamides, polycarbonates, glass fiber fabrics and composite materials made from glass fibers and polymeric materials.

34. The method according to claim 25, further comprising the step of cleaning the printing element after the laser engraving step using water or an alcohol.
